(19) United States
(12) Patent Application Publication
(10) Pub. No.: US 2015/0345155 A1
(43) Pub. Date: Dec. 3, 2015

(54) FLOORING UNDERLAYMENT AND APPARATUS, FLOORING SYSTEM AND FLOOR INSTALLATION METHOD USING THE SAME

(71) Applicant: ARMSTRONG WORLD INDUSTRIES, INC., Lancaster, PA (US)

(72) Inventor: TONY T. PASTRANA, Millersville, PA (US)

(21) Appl. No.: 14/762,247

(22) PCT Filed: Jan. 28, 2014
(86) PCT No.: PCT/US2014/013446

§ 371 Date: Jul. 21, 2015

Related U.S. Application Data
(60) Provisional application No. 61/757,580, filed on Jan. 28, 2013.

(51) Int. Cl. E04F 15/18; B32B 5/02

(52) U.S. Cl. CPC E04F 15/182; B32B 5/022

(57) ABSTRACT

A flooring underlayment is disclosed that is particularly useful for the installation and formation of floating floor systems. In on embodiment, the invention can be an integral composite underlayment comprising: a flexible support layer having an upper surface and a lower surface; a pre-applied adhesive layer disposed on the upper surface of the flexible support layer, and a release layer coupled to disposed on the adhesive layer.

### CROSS-REFERENCE TO RELATED PATENT APPLICATIONS

The present application claims the benefit of U.S. Provisional Patent Application Ser. No. 61/757,580, filed Jan. 28, 2013, the entirety of which is hereby incorporated by reference.

### FIELD OF THE INVENTION

The present application relates generally to underlayments for floor coverings, and specifically to integral composite underlayments for floor coverings, such as floating floors, that include a release layer that can be removed to expose an adhesive layer.

### BACKGROUND OF THE INVENTION

Surface coverings such as decorative finished floor coverings, often require an underlayment to be installed over a support surface, such as a structural wood or concrete subfloor. In traditional flooring systems, the underlayment is attached to the support surface by adhesives, nails, screws, staples or any combination thereof. In floating floor systems, which have become popular in recent years, the underlayment is simply positioned atop the support surface and not secured thereto in any manner, thereby allowing the underlayment (and eventually the floor covering that is positioned atop the underlayment) to “float” relative to the support surface.

In both types of flooring systems, the underlayment serves as a foundation for application of the floor covering, and provides a smooth surface upon which to lay the floor covering. A smooth surface is desirable so that the subfloor's texture or graining is not telegraphed through to the viewable surface of the floor covering.

In known application techniques, an underlayment is positioned atop the support surface. Once in proper position, a liquid adhesive is applied to the exposed upper surface of the underlayment. The floor covering is then laid over the adhesive to bond the floor covering to the underlayment. Typically, adhesives are applied at the installation location by employing a trowel to spread the adhesive on the underlayment, which is a labor intensive and often messy process.

Another known practice is to pre-apply an adhesive layer directly onto the back of the floor covering. These pre-applied adhesives have been utilized for carpet installation. Such techniques, however, are not suitable for adhering floor coverings such as vinyl flooring to a subfloor because it provides too much cushioning and not enough resiliency to protect the floor coverings, such as vinyl sheets, tiles, veneers, and high pressure laminate flooring from indent or deflection-type damage from concentrated loads. Moreover, other known practices pre-apply adhesive to both sides of a carpet pad, which eliminates the possibility of a floating floor arrangement.

Although various methods of adhering a floor covering to an underlayment are known, the need for a composite underlayment that provides for ease of installation of floor coverings remains.

### BRIEF SUMMARY OF THE INVENTION

In one aspect, the invention can be an integral composite underlayment that includes a flexible support layer having an upper surface and a lower surface; a pressure sensitive adhesive layer disposed on the upper surface; and a release layer disposed on the adhesive layer. In certain embodiments, an insulating layer, such as a flocked material, may be disposed on the lower surface of the flexible support layer to ensure that the integral composite underlayment achieves desired IIC sound ratings.

In another aspect, the invention can be an underlayment apparatus for a floating floor, the underlayment apparatus comprising: a core tube; an integral composite underlayment wrapped around the core tube, the integral composite underlayment alterable between: (1) a rolled state in which the integral composite underlayment is wrapped around the core tube; and (2) an unrolled state in which the integral composite underlayment lays substantially flat on a support surface; the integral composite underlayment comprising: a flexible support layer having an upper surface and a lower surface; a pressure sensitive adhesive layer disposed on the upper surface of the flexible support layer; and a release layer disposed on the pressure sensitive adhesive layer. In certain embodiments of the underlayment apparatus, the integral composite underlayment may also include an insulating layer provided on the lower surface of the flexible support layer.

In a further aspect, the invention can be a floor system installed atop a support surface, the floating floor system comprising: a run of an integral composite underlayment non-fixedly positioned atop the support surface, the integral composite underlayment comprising: a flexible support layer having an upper surface and a lower surface; a pre-applied adhesive layer on the upper surface of the flexible support layer, the pre-applied adhesive layer having been exposed by removing a release layer; and a plurality of floor panels adhered to the integral composite underlayment by the pre-applied adhesive layer in a desired pattern. Again, the integral composite underlayment used in the floor system may also include an insulating layer provided on the lower surface of the flexible support layer. If a floating floor system is desired, neither the underlayment nor the plurality of floor panels are secured to the support surface in any manner. In such embodiments, the floor system is free of adhesives (or any other fasteners) between the integral composite underlayment and the support surface.

In an even further aspect, the invention can be a method of installing a floating floor atop a support surface, the method comprising: a) positioning an integral composite underlayment atop the support surface in a free floating arrangement, the integral composite underlayment comprising: a flexible support layer having an upper surface and a lower surface, a pressure sensitive adhesive layer disposed on the upper surface of the flexible support layer, and a release layer disposed on the pressure sensitive adhesive layer; b) peeling away at least a portion of the release layer to expose at least a portion the pressure sensitive adhesive layer; and c) pressing a plurality of floor panels against the exposed portion of the pressure sensitive adhesive layer, thereby adhering the plurality of floor panels to the integral composite underlayment in a desired pattern. The integral composite underlayment may also comprise an insulating layer disposed on the lower surface of the flexible support layer.

In yet another aspect, a method of installing a floor covering such as over a structural support such as a subfloor is disclosed. The method includes providing a composite underlayment as disclosed herein and positioning it on a support surface so that the insulation layer contacts the structural support such as in the absence of adhesive. The release layer is removed from the composite underlayment to expose the adhesive layer and a floor covering then is compressed onto the adhesive layer. The composite underlayment need not be affixed to the support surface so as to enable the underlayment to float on the structural support.

In even another aspect, the invention can be a method of replacing an undesirable floor panel of a floating floor system that is installed atop a support surface, the floating floor system comprising: an integral composite underlayment positioned atop the support surface in a floating arrangement, the integral composite underlayment comprising: a flexible support layer having an upper surface and a lower surface; a pre-applied adhesive layer on the upper surface of the flexible support layer, the pre-applied adhesive layer having been exposed by removing a release layer; a plurality of floor panels adhered to the integral composite underlayment by the pre-applied adhesive layer in a desired pattern, the method comprising: a) peeling the undesirable floor panel off of the pre-applied adhesive layer to expose a portion of the pre-applied adhesive layer; and b) pressing a replacement floor panel onto the exposed portion of the pre-applied adhesive layer to adhere the replacement floor panel to the integral composite underlayment; wherein no additional adhesive is used to adhere the replacement floor panel to the integral composite underlayment.

Further areas of applicability of the present invention will become apparent from the detailed description provided hereinafter. It should be understood that the detailed description and specific examples, while indicating the preferred aspects of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a perspective view of an underlayment apparatus according to an embodiment of the present invention, wherein the integral composite underlayment is in a rolled state;

FIG. 2 is a side plan view of the underlayment apparatus of FIG. 1;

FIG. 3 is a perspective view of the underlayment apparatus of FIG. 1, wherein the integral composite underlayment has been partially unrolled from the core tube;

FIG. 4 is a cross-sectional schematic of an integral composite underlayment in accordance with an embodiment of the present invention, taken along view IV-IV of FIG. 3;

FIG. 5 is a perspective view of the underlayment apparatus of FIG. 1 in which the integral composite underlayment is being unrolled onto a support surface during a flooring installation process according to an embodiment of the present invention;

FIG. 6 is a perspective view of the integral composite underlayment of FIG. 5 in a fully unrolled state atop the support surface, and wherein a corner of the release layer is being peeled away to expose a portion of the pre-applied adhesive layer, during a flooring installation process according to an embodiment of the present invention;

FIG. 7 is a perspective of the integral composite underlayment of FIG. 6 in which a plurality of floor panels have been adhered to the exposed portion of the pre-applied adhesive layer in a desired pattern, during a flooring installation process according to an embodiment of the present invention;

FIG. 8 is a perspective view of first and second runs of an integral composite underlayment in accordance with an embodiment of the present invention in which a first side edge portion of the second run is positioned beneath an edge region of the first run of the integral composite underlayment that is free of the insulating layer; and

FIG. 9 is a cross-sectional schematic of view IX-IX of FIG. 8 in which the floor panels have been adhered to the exposed portion of the pre-applied adhesive layers of the first and second runs of the integral composite underlayment.

### DETAILED DESCRIPTION OF THE INVENTION

The following description of the preferred embodiment(s) is merely exemplary in nature and is in no way intended to limit the invention, its application, or uses.

The description of illustrative embodiments according to principles of the present invention is intended to be read in connection with the accompanying drawings, which are to be considered part of the entire written description. In the description of embodiments of the invention disclosed herein, any reference to direction or orientation is merely intended for convenience of description and is not intended in any way to limit the scope of the present invention. Relative terms such as “lower,” “upper,” “horizontal.” “vertical,” “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise. Moreover, the features and benefits of the invention are illustrated by reference to the exemplified embodiments. Accordingly, the invention expressly should not be limited to such exemplary embodiments illustrating some possible non-limiting combination of features that may exist alone or in other combinations of features; the scope of the invention being defined by the claims appended hereto.

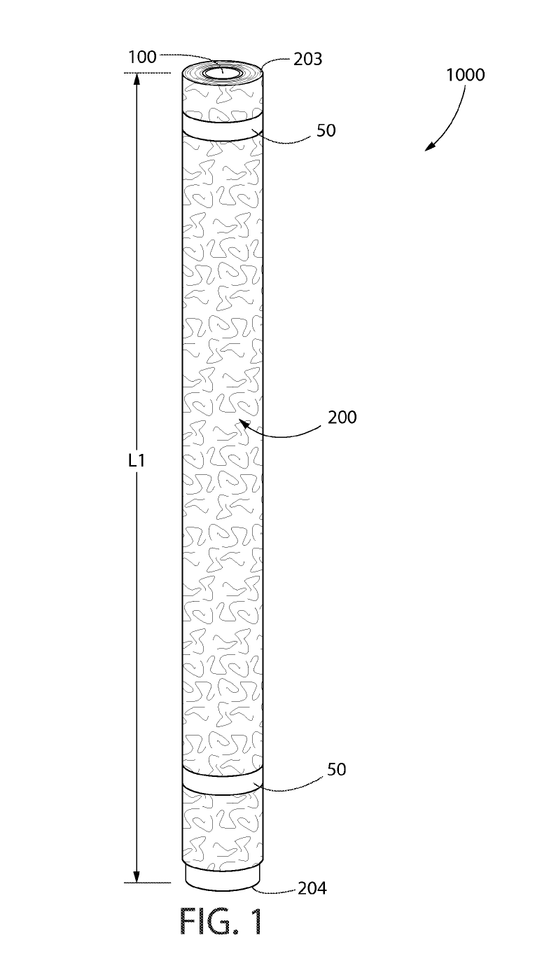

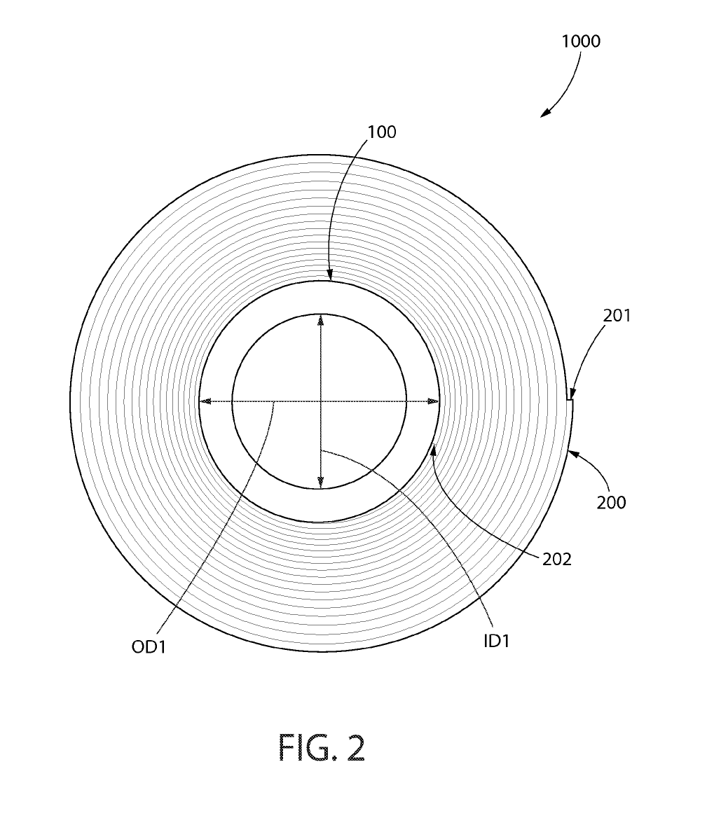

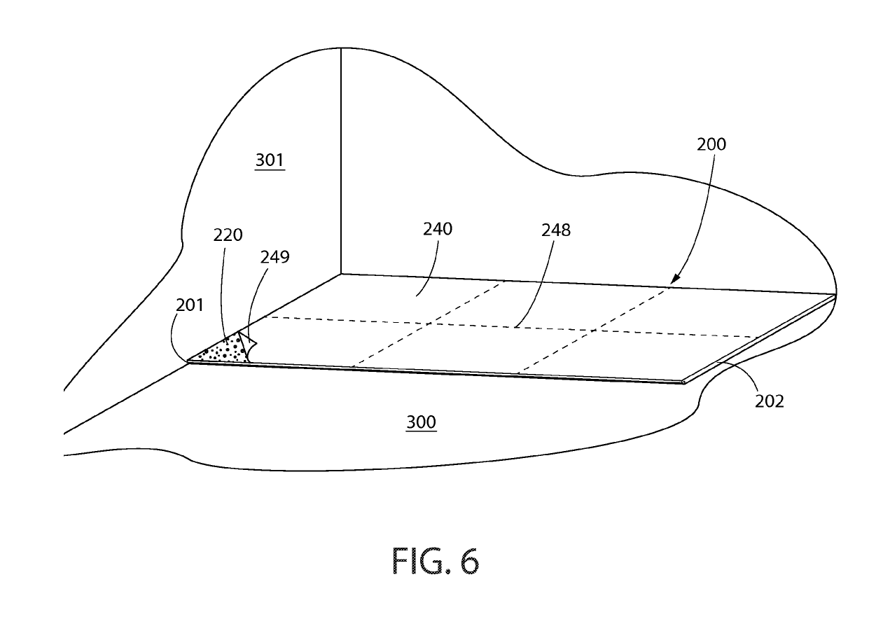

Referring first to FIGS. 1-4 concurrently, an underlayment apparatus 1000 is illustrated in accordance with an embodiment of the present invention. The underlayment apparatus 100 generally comprises a core tube 100 and an integral composite underlayment 200. The integral composite underlayment 200 is alterable between: (1) a rolled state in which the integral composite underlayment 200 is wrapped around the core tube (FIG. 1); and (2) an unrolled state in which the integral composite underlayment 200 lays substantially flat on a support surface 300 (FIG. 6).

The underlayment apparatus 1000, in the exemplified embodiment, further comprises a pair of bounding elements 50 that maintain the integral composite underlayment 200 in the rolled state about the core tube 100. As exemplified, the bounding elements 50 wrap around the circumference of the integral composite underlayment 200 in the rolled state. Suitable bounding elements include, without limitation, tape, rope, staples, string, clamps, and combinations thereof

The integral composite underlayment 200 is a flexible multi-layer sheet that can be rolled about the core tube 100 without cracking or otherwise structurally compromising the integral composite underlaymnent 200. As used herein, a material or structure is “flexible” when said material or structure bends 45 degrees or more under its own weight when supported at only one end thereof in a cantilevered manner. In addition, a material or structure is “flexible” when said material or structure can be rolled about the entire circumference of a cylindrical tube having an outer diameter of 5 inches or less without visible cracking and/or structurally compromising the material or structure.

As discussed in greater detail below, the integral composite underlayment 200 can be used for the installation of a floor covering (such as a plurality of floor panels 400) on a support surface 300. The integral composite underlayment 200 provides a floating base to which the floor covering can be bonded to a pre-applied adhesive layer 220, thereby eliminating the need for on-site application of an adhesive to the integral composite underlayment 200 in the field during installation. While the integral composite underlayment 200 is described herein as being provided in the form of a roll, the integral composite underlayment 200 may also be provided in the form of flat sheets

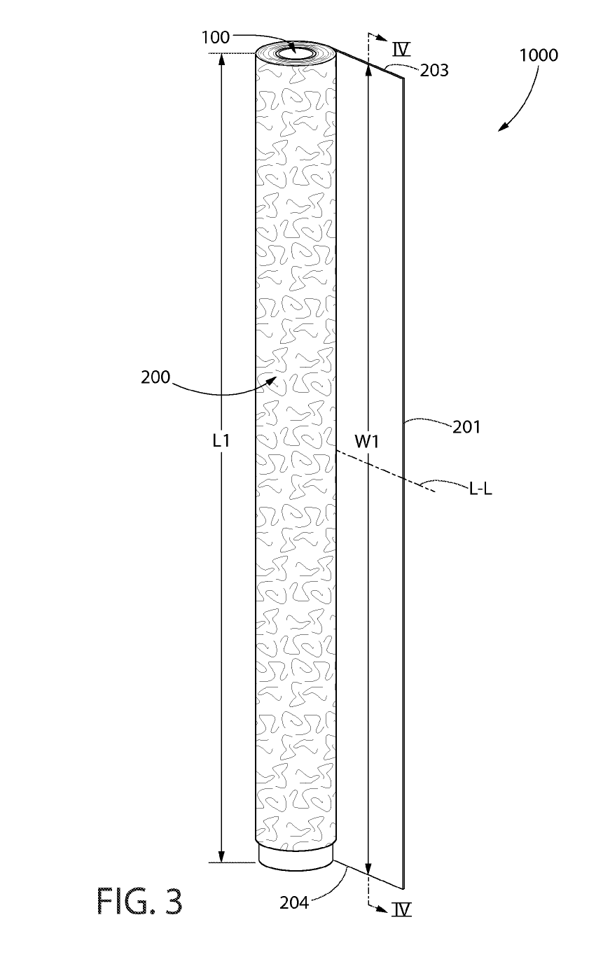

The integral composite underlayment 200 extends from a lead edge 201 to a trail edge 202 along a longitudinal axis L-L (only a portion of which is shown in FIG. 3), thereby defining the length of the integral composite underlayment 200. In one preferred embodiment, the integral composite underlayment 200 has a length in a range of 25 to 100 ft., more preferably 30 to 50 ft., and most preferably about 40 ft. As exemplified, the integral composite underlayment 200 is wrapped around the core tube 100 in a direction of the length of the integral composite underlayment 200. The integral composite underlayment 200 also extends transversely from a first side edge 203 to a second side 204, thereby defining the width W1 of the integral composite underlayment 200. In one preferred embodiment, the integral composite underlayment 200 has a width W1 in a range of 3 to 10 ft., more preferably 4 to 6 ft., and most preferably about 5 ft. In certain embodiments, the length of the integral composite underlayment 200 is greater than the width W1 of the integral composite underlayment 200.

The first and second side edges 203, 204 of the integral composite underlayment 200 extend substantially parallel to one another in the exemplified embodiment. Thus, the width W1 of the integral composite underlayment 200 is substantially constant along the length of the integral composite underlayment 200.

The core tube 100, as exemplified, is a hollow corrugated tube having an inner diameter ID1 and an outer diameter OD1. In other embodiments, the core tube 100 may be a solid cylindrical tube if desired. The core tube 100 has a length L1 that is substantially equal to the width W1 of the integral composite underlayment 200. Thus, when the integral composite underlayment 200 is wrapped around the core tube 100 in the rolled state, the core tube 100 extends through the substantial entirety of the roll. In one preferred embodiment, the core tube 100 has an outer diameter OD1 in a range of 2 to 6 inches, more preferably 2 to 4 inches, and most preferably about 3 inches.

The integral composite underlayment 200 generally comprises a flexible support layer 210, an adhesive layer 220, an insulating layer 230, and a release layer 240. The flexible support layer 210 comprises an upper surface 211 and a lower surface 212. The insulating layer 230 is disposed on the lower surface 212 of the flexible support layer 210. The adhesive layer 220 is disposed on the upper surface 211 of the flexible support layer 210. In the exemplified embodiment, the insulating layer 230 is disposed directly on the lower surface 212 of the flexible support layer 210 with no intervening layers existing. Similarly, in the exemplified embodiment, the adhesive layer 220 is disposed directly on the upper surface 211 of the flexible support layer 210 with no intervening layers existing. In certain other embodiments, however, one or more intervening layers may be provided between the insulating layer 230 and the flexible support layer 210 and/or between the flexible support layer 210 and the adhesion layer 220. In still other embodiments, the insulating layer 230 may be omitted. In one such arrangement, the integral composite underlayment 200 may include only the flexible support layer 210, the adhesive layer 220, and the release layer 240.

The insulating layer 230 has a thickness t1 measured from its upper surface 231 to its lower surface 232. The flexible support layer 210 has a thickness t2 measured from its upper surface 211 to its lower surface 212. The adhesive layer 220 has a thickness t3 measured from its upper surface 221 to its lower surface 222. The release layer 240 has a thickness t4 measured from its upper surface 241 to its lower surface 242. In one embodiment, the thickness t1 of the insulating layer 230 may be greater than the thickness t2 of the flexible support layer 210. The thickness t2 of the flexible support layer 210 may be greater than the thickness t4 of the release layer 240. The thickness t4 of the release layer 240 may be greater than the thickness t3 of the adhesive layer 240. Thus, the thicknesses t1 to t4 may have the following relative relationship: t1>t2>t4>t3 in certain embodiments.

In one embodiment, the thickness t1 of the insulating layer 230 is greater than a combined thicknesses t2+t3+t4 of the release layer 240, the adhesive layer 220, and the flexible support layer 210. In one preferred embodiments, the thicknesses t1 to t4 are selected such that a ratio of the thickness t1 of the insulating layer 230 to the combined thicknesses t2+t3+t4 of the release layer 240, the adhesive layer 220, and the flexible support layer 210 is at least 1.1:1, more preferably at least 1.3:1, even more preferably in a range of 1.1:1 to 1.5:1, and most preferably about 1.3:1.

In one preferred embodiment, the insulating layer 230 may have a thickness t1 in a range of 5 to 50 mils, more preferably in a range of 10 to 40 mils, even more preferable in a range of 15 to 35 mils, and most preferably about 23 mils. The flexible support layer 210 may have a thickness t2 in a range of 5 to 50 mils, more preferably in a range of 5 to 15 mils, even more preferable in a range of 6 to 10 mils, and most preferably about 8 mils. The adhesive layer 220 may have a thickness t3 in a range of 0.5 to 10 mils, more preferably in a range of 1 to 5 mils, even more preferable in a range of 1 to 3 mils, and most preferably about 1 mil. The release paper may have a thickness t3 in a range of 2 to 10 mils, more preferably in a range of 2 to 5 mils, and most preferably in a range of 3 to 4 mils. Of course, in certain other embodiments, the thickness t1 to t4 of each of the flexible support layer 210, the adhesive layer 220, the insulating layer 230, and the release layer 240 may be varied as desired.

The integral composite underlayment 200 has a total thickness t5 which, in the exemplified embodiment, is measured from the lower surface 232 of the insulating layer 230 and the upper surface 241 of the release layer 240. The thickness t5 of the integral composite underlayment 200, in the exemplified embodiment, is the sum of t1+t2+t3+t4. In one embodiment, the thickness t5 of the integral composite underlayment 200 is in a range of 20 to 150 mils, more preferably 20 to 50 mils, even more preferably 25 to 40 mils, and most preferably about 35 mils.

As mentioned above, the core tube 100 has an outer diameter OD1. In certain embodiments, the thickness t5 of the integral composite underlayment 200 and the outer diameter OD1 of the core tube 100 are selected such that a ratio of the outer diameter OD1 of the core tube 100 to the thickness t5 of the integral composite underlayment 200 is within the range of 70:1 to 100:1, more preferably in a range of 80:1 to 90:1, and most preferably about 85:1. In other embodiments, the outer diameter OD1 of the core tube 100 and the thickness t2 of the flexible support layer 210 may be selected such that a ratio of the outer diameter OD1 of the core tube to the thickness t2 of the flexible support layer 210 is within a range of 350:1 to 400:1, more preferably in a range of 360:1 to 380:1, and most preferably about 375:1.

The flexible support layer 210 may be formed of materials typically suitable to form substrate sheets for flooring underlayments. Suitable materials include, without limitation, vinyl, plastic, polyvinyl chloride, polyester or combinations thereof. Such materials are commercially available in a wide variety of shapes and sizes from sources such as Klockner Pentaplast. The flexible support layer 210 may be in the form of multiple layers or a single layer of material or combinations of materials.

The insulating layer 230, which is disposed on the lower surface 212 of the flexible support layer 210, may provide sound insulation to the integral composite underlayment 200 and further enable the integral composite underlayment 200 to accommodate uneven surfaces such as old tile, seams, and imperfections in a support surface. The insulating layer 230 may be formed of a variety of materials, the exact material being selected based on the desired characteristics of the integral composite underlayment 200. Suitable materials include, without limitation, high-density foams, rubbers, fibrous materials, felts, and combinations thereof.

In one embodiment, the insulating layer 230 is formed of a flock material, such as those commercially available from Flexcon Company, Inc. In certain embodiments in which the insulating layer 230 is formed of a flock material, the flock material may comprise fibers, such as acrylic fibers. In one specific embodiment, suitable dimensions for the fibers of the flock material may be a fiber length of 0.4 to 0.8 mm and a fiber diameter of 9 to 14 microns. In one preferred arrangement, the fibers of the flock material may have a fiber length of 0.5 to 0.7 mm and a fiber diameter of 10 to 13 microns, wherein a fiber length of 0.6 mm and a fiber diameter of ii to 12 microns is most preferred.

Various types of flocking methods, such as roll coating and electrostatic-based flocking, may be used to attach the flock material (i.e., the fibers) to the lower surface 212 of the flexible support layer 210. In one non-limiting example, the flexible support layer 210 is fed through a flocking machine. In the flocking machine, the flock material is given a negative charge while the flexible support layer 210 is grounded. As a result, the flock material flies vertically onto the lower surface 211 of the flexible support layer 210, which may have an adhesive previously applied thereto. Another suitable flocking process is described in U.S. published patent application 20130008055, the teachings of which are incorporated by reference herein by their entirety.

The adhesive layer 220, which is disposed on the upper surface 211 of the flexible support layer 210, is a pre-applied adhesive. As used herein, the term “pre-applied adhesive” means that the adhesive is not applied to the flexible support layer 210 in the field during installation, but is rather applied to the flexible support layer 210 prior thereto, such as by the manufacturer of the integral composite underlayment 200. In one example, the adhesive layer 220 is pre-applied to the flexible support layer 210 by the factory.

A non-limiting method of pre-applying the adhesive layer 220 to the flexible support layer 210 in a factory-setting entails feeding adhesive into a calender at a desired temperature. The calender nip opening of the calender is adjusted to a desired thickness of adhesive layer, and the adhesive layer is coated directly onto the upper surface 211 of flexible support layer 210 by bringing the flexible support layer 210 into contact with a calender transfer roll in a continuous process. The release layer 240 may then be applied over the adhesive layer 220

The adhesive layer 220, in certain embodiments, is a pressure sensitive adhesive that is pre-applied to the flexible support layer 210 as discussed above. The pressure sensitive adhesive employed as the adhesive layer 220 may include any adhesive that creates a bond with the upper surface 211 of the flexible support layer 210 (and subsequently the release layer 220) by contact and pressure. A variety of pressure sensitive adhesives therefore may be used, such as a permanent pressure sensitive acrylic adhesive. One suitable permanent pressure sensitive acrylic adhesive is commercially available from Flexcon Company, Inc. under the tradename Flexmark V-478. In certain embodiments, the pressure sensitive adhesive layer may have a tack value between 740 to 800 gm. As discussed in greater detail below, in certain embodiments, the pressure sensitive adhesive may be substantially transparent so that visual indicia on the upper surface 211 of the flexible support layer 210 is visible therethrough once the release layer 240 is peeled away.

Other types of adhesives that may be employed include but are not limited to organic solvent-based, water-based, hot melt adhesives and acrylic adhesives. For example, organic solvent and water-based adhesives include without limitation styrene butadiene rubber, styrene isoprene rubber, polyisobutylene rubber, styrene-isoprene-styrene (“SIS”) and styrene-butadiene-styrene (“SBS”) block copolymer rubbers, natural rubber, acrylic homopolymers and copolymers, vinyl acetate copolymers, polyesters, polyurethanes, and asphalt. Hot melt pressure sensitive adhesives may also be employed and include, without limitation, amorphous polypropylene, polyisobutylene, ethylene vinyl acetate, polyesters, ethylene acrylic acid copolymers, SIS and SBS block copolymer rubbers, and polyurethanes. These organic solvent-based, water-based, and hot melt adhesive polymers may be blended with one or more lower molecular weight tactifying resins, such as aliphatic and aromatic hydrocarbons or rosin esters. Additionally, such adhesives may include plasticizing oils or plasticizers. Further, the adhesive may be a blend of two or more of these polymers to achieve desired performance characteristics.

The release layer 240 may, in certain embodiments, may include a release paper, a release film, or combinations thereof. The release layer 240, in one embodiment, is a sheet of cellulosic material comprising a wax coating, a polymer coating, or combinations thereof. Polymer coatings that may be used include but are not limited to carbon based polymers such as but not limited to polyolefin copolymers, polyesters, polyamides, polyimides, polyurethanes and combinations thereof, as well as silicone coating having silicone monomers and/or polymers and combinations thereof. In other embodiments, the release layer 240 may be formed of polyolefin copolymers, polyesters, polyamides, polyimides, and polyurethanes and combinations thereof. One suitable release paper is available from Peterson Scanproof, Saffle, Sweden

In one embodiment, the integral composite underlayment has an IIC sound rating greater than 50, more preferably greater than 60, and most preferably about 66. In certain embodiments, the integral composite underlayment 200 is designed to have a weight per area between 0.07 to 0.10 pounds per square foot, more preferably between 0.080 to 0.085 pounds per square foot, and most preferably about 0.083 pounds per square foot.

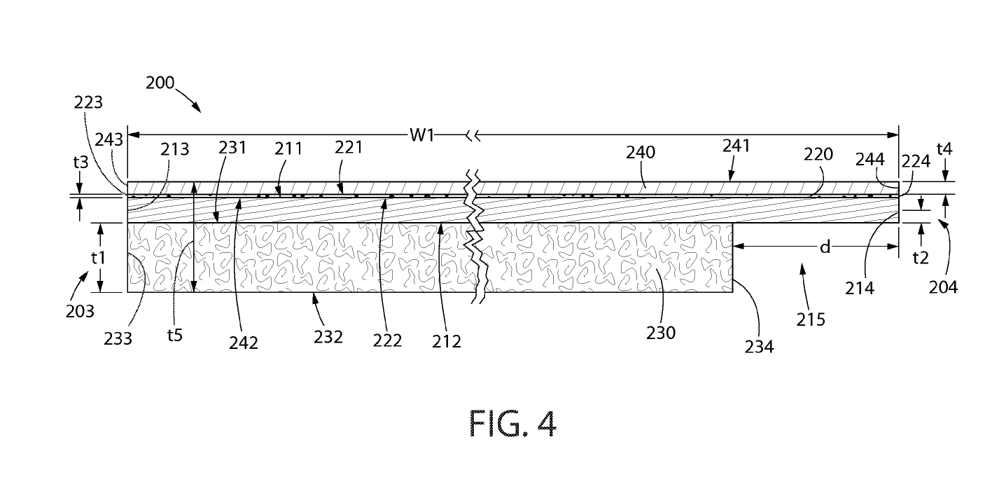

The flexible support layer 210 further comprises a first side edge 213 and a second side edge 214 that define the width of the flexible support layer 210 (which in the exemplified embodiment is the same as the width W1 of the integral composite underlayment 200, shown in FIG. 4). The insulating layer 230 also comprises a first side edge 233 and a second side edge 234 that define the width of the insulating layer 230. In the exemplified embodiment, the width of the insulating layer 230 is less than the width of the flexible support layer 210.

As can be seen in FIG. 4, the second side edge 234 of the insulating layer 230 is inwardly offset (toward the longitudinal axis L-L) from the second side edge 214 of the flexible support layer 210 by a distance d, thereby resulting in the lower surface 212 of the flexible support layer 210 comprising an edge region 215 that is free of the insulating layer 230. In one embodiment, the distance d is in a range of 0.5 to 5 inches, more preferably in a range of 1 to 3 inches, and most preferably about 1 inch.

The edge region 215 of the lower surface 212 of the flexible support layer 210 is also free of any adhesive in the exemplified embodiment, as is the lower surface 232 of the insulating layer 230. Thus, in certain embodiments, the exposed lower surface of the integral composite underlayment 200 (which in the exemplified embodiment is formed by the combination of the lower surface 232 of the insulating layer 230 and the edge region 215 of the lower surface 212 of the flexible support layer 210) is free of an adhesive, thereby making the integral composite underlayment 200 ideal for use to create a floating floor.

While not visible from the illustrations, the edge region 215 of the lower surface 211 of the flexible support layer 210 extends along an entire length of the integral composite underlayment 200 (i.e., from the lead edge 201 to the trail edge 202). Moreover, in certain embodiments, such as the one exemplified, the second side edges 234, 214 of the insulating and flexible support layers 230, 210 extend substantially parallel to one another along the entire length of the integral composite underlayment 200.

While the second side edges 234, 214 of the insulating and flexible support layers 230, 210 are offset from one another, the first side edges 233, 213 of the insulating and flexible support layers 230, 210 are substantially flush with one another. Additionally, in the exemplified embodiment, the adhesive layer 220 comprises a first side edge 223 that is also substantially flush with the first side edges 233, 213 of the insulating and flexible support layers 230, 210 and a second side edge 224 that is substantially flush with the second side edge 214 of the flexible support layer 210. Similarly, the release layer 240 comprises a first side edge 243 that is also substantially flush with the first side edges 233, 213, 223 of the insulating, flexible support and adhesive layers 230, 210, 220 and a second side edge 244 that is substantially flush with the second side edges 214, 224 of the flexible support and adhesive layers 210, 220. Thus, in the exemplified embodiment, the first side edges 233, 213, 223, 243 of the insulating, flexible support, adhesive, and release layers 230, 210, 220, 240 collectively define the first side edge 203 of the integral composite underlayment 200. The second side edges 214, 224, 244 of the flexible support, adhesive, and release layers 210, 220, 240 collectively define second side edge 204 of the integral composite underlayment 200.

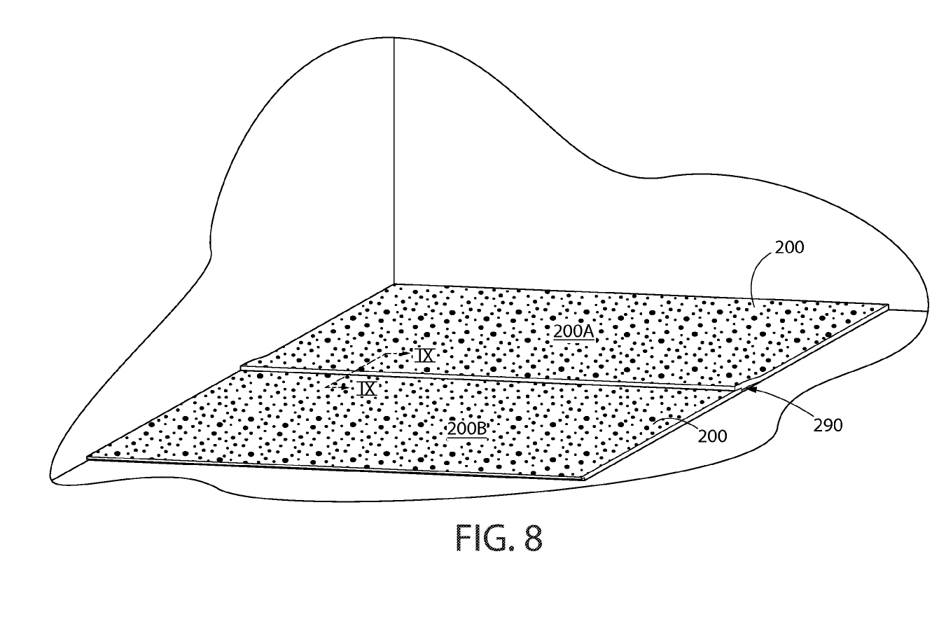

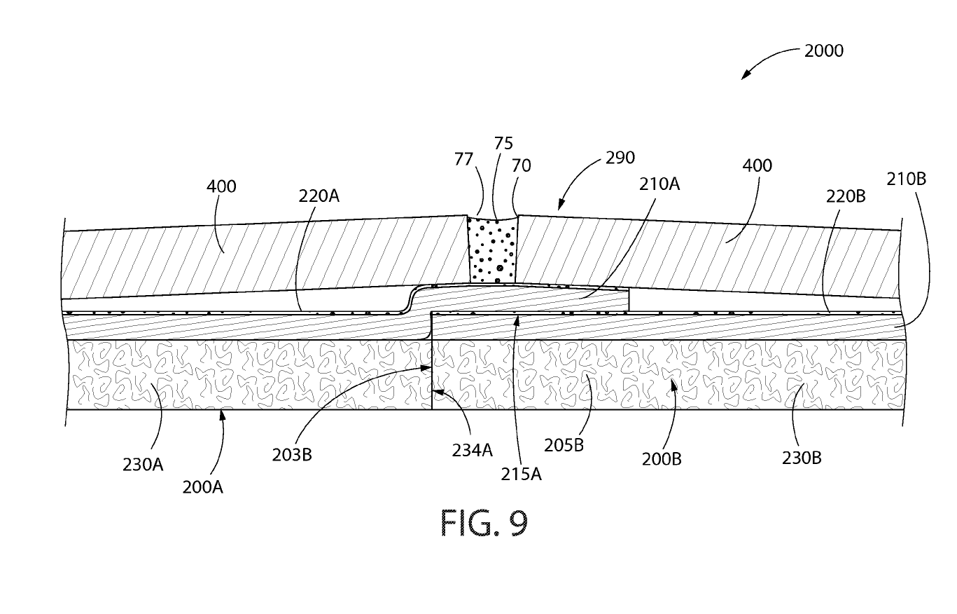

As will be discussed in greater detail below, by inwardly offsetting the second side edge 234 of the insulating layer 230 from the second side edge 214 of the flexible support layer 210 by the distance d, a stepped profile is formed that is used during the installation process for a floating floor to form overlap seams 290 (FIGS. 8-9) that do not negatively affect the appearance and/or functioning of the floating floor system. As can be seen in FIG. 4, the integral composite underlayment 200 has a substantially reduced thickness (t2+t3+t4) along the edge region 215, as compared to the thickness (t1+t2+t3+t4) of the remaining portion of the integral composite underlayment 200 extending from the second side edge 234 of the insulating layer 230 to the first side edge 203 of the integral composite underlayment 200. This reduced thickness is the result of the absence of the insulating layer 230 which, as discussed above, has a thickness t1 that is greater than the combination of the thicknesses (t2+t3+t4) of the flexible support, adhesive, and release layers 210, 220, 240.

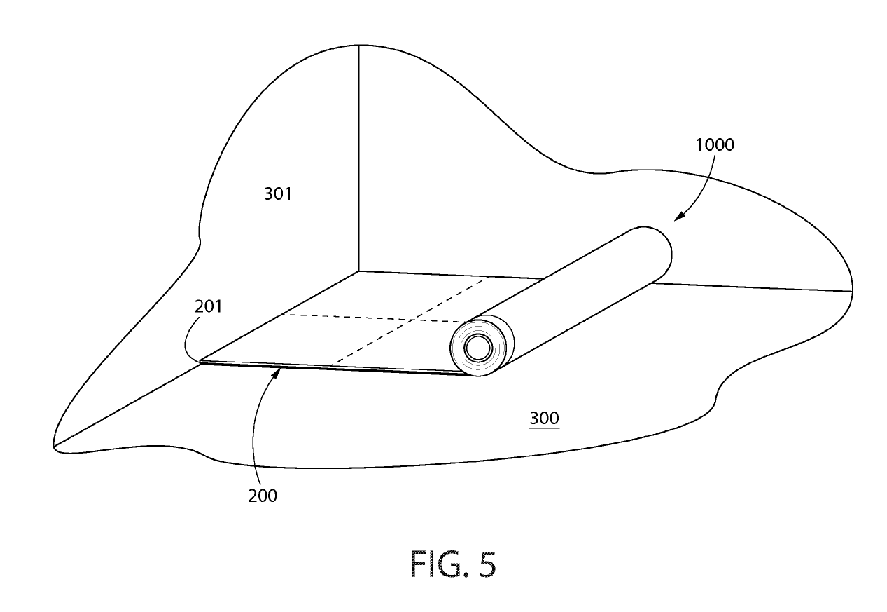

Referring now to FIG. 5-7, a method of installing a floating floor system 2000 atop a support surface 300 using the underlayment apparatus 1000 will now be described. Referring first to FIG. 5, the underlayment apparatus 1000 described above with respect to FIGS. 1-4 is provided. The integral composite underlayment 200 is in the rolled state. The integral composite underlayment 200 is then partially unrolled from the core tube 100 and the lead edge 201 of the integral composite underlayment 200 is abutted against a vertical surface 301 (such as a wall). The underlayment apparatus 1000 is then rolled away from the vertical surface 301, thereby releasing additional length of the integral composite underlayment 200 from the core tube 100 that lies substantially flat on the support surface 300.

Referring now to FIG. 6, once a desired length of the integral composite underlayment 200 is unrolled from the core tube 100, the integral composite underlayment 200 is cut, thereby defining the terminal edge 202 of the integral composite underlayment 200. In certain embodiment, the terminal edge 202 of the integral composite underlayment 200 may abut another vertical surface in the room, such as a wall or other structure. At this point, the integral composite underlayment 200 lays atop the support surface 300 in a free floating arrangement (i.e., it is no way secured to the support surface). Thought of another way, the integral composite underlayment 200 is in slidable surface contact with the support surface 300 and, if not for being in abutment with the vertical surfaces 301, the integral composite underlayment 200 would be able to freely slide atop the support surface 300 once the friction force is overcome.

As can be seen in FIG. 6, the release layer 240 comprises gridline indicia 248 on the upper surface 241 of the release layer 240. The gridline indicia 248 is provided to facilitate proper placement of floor panels 400 atop the integral composite underlayment 200 so that the floor covering can be created in the desired geometric pattern with accuracy and proper placement. In the exemplified embodiment, the gridline indicia 248 is formed by pre-weakened lines that delineate the release layer 240 into sections for separate removal from the pressure sensitive adhesive layer 220. The pre-weakened lines can be in the form of perforated lines, score lines, crease lines, chemically weakened lines, or combinations thereof. In other embodiments, the gridline indicia 248 may be formed by a printing, debossing, or other process. In other embodiments, pre-weakened lines can be provided on the release layer 240 so that sections of the release layer 240 can be separately removed without forming a grid pattern. Alternatively, chalk lines may be snapped onto the release layer 240 and thereafter scored in the field, such as with a utility knife to generate score lines to aid removal of specific portions of the release layer 240.

Once the integral composite underlayment 200 is in the desired position atop the support surface, a corner 249 of the release layer 240 is peeled back, thereby exposing a portion of the adhesive layer 220. The corner 249 of the release layer 240 continues to be peeled away until a desired area of the adhesive layer 220 is exposed. The peeled-away section of the release layer 240 is then torn along the pre-weakened lines of the gridline indicia 248, thereby allowing the peeled-away section of the release layer 240 to be removed from the integral composite underlayment 200 while allowing the remainder of the release layer 240 to remain in place. As mentioned above, the adhesive layer 220 is pre-applied to the upper surface 211 of flexible support layer 201 prior to use at the job site and, thus, there is no need for the installer to use a trowel to apply additional adhesive.

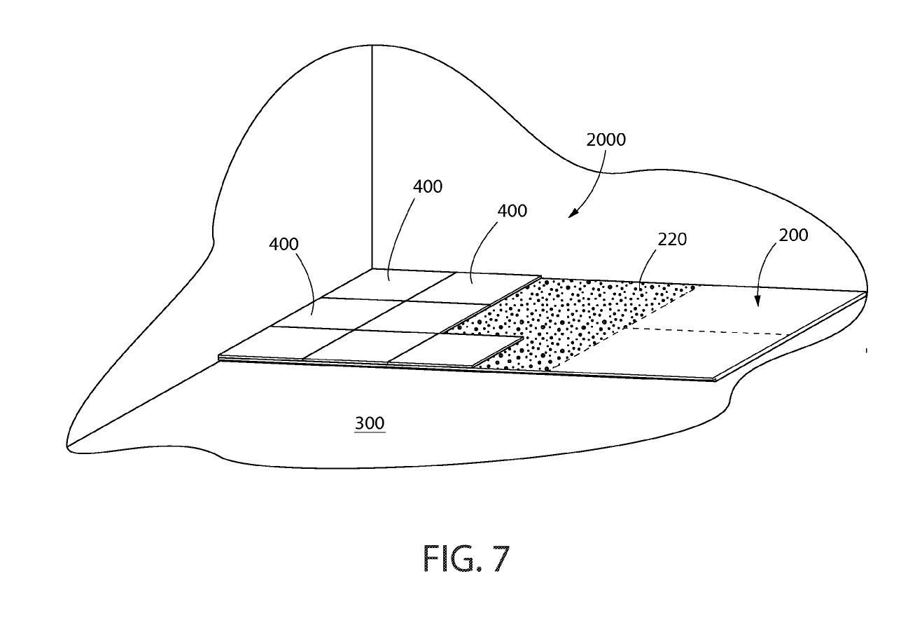

Referring now to FIG. 7, once the desired portion of the release layer 240 is removed from the remainder of the integral composite underlayment 200, a plurality of floor panels 400 are pressed against the exposed portion of the adhesive layer 220, thereby adhering the plurality of floor panels 400 to the integral composite underlayment 200 in a desired pattern. The above process is repeated until the entire support surface 300 is covered by the floating floor system 2000.

In one embodiment, the plurality of floor panels 400 can be vinyl tiles. The vinyl tiles may, for example be, groutable vinyl tiles, such as the Alterna vinyl tiles commercially available from Armstrong World Industries, Inc.

In some embodiments, the floor panels 400 comprise a core. In some embodiments, the core comprises a top core layer and a bottom core layer. In some embodiments, the top core layer comprises a vinyl polymer. In some embodiments, the bottom core layer comprises a vinyl polymer. In some embodiments, the floor panels 400 comprise a fiberglass mat. In some embodiments, the floor panels 400 comprise a woven fiberglass mat. In some embodiments, the floor panels 400 comprise a printed decorative film layer. In some embodiments, the floor panels 400 comprise a textured backing layer. In some embodiments, the floor panels 400 comprise a wear layer. In some embodiments, the wear layer is UV curable. In some embodiments, the wear layer comprises polyurethane. In some embodiments, the wear layer comprises wear resistant particles. In some embodiments, the wear resistant particles are selected from aluminum oxide, silica and silicon carbide. In some embodiments, the wear resistant particles comprise aluminum oxide. Some embodiments provide floor panels 400 comprising a wear layer; a printed decorative film layer; a core comprising a top core layer and a bottom core layer; a fiberglass mat; and a textured backing layer.

In some embodiments, the floor panels 400 have varying tactile characteristics. In some embodiments, the floor panels 400 comprise a surface coating having varying tactile characteristics. In some embodiments, the surface coating comprises a resin and texture particles. In some embodiments, the surface coating has a uniform gloss. In some embodiments, the texture particles are selected from polyetheretherketone particles, polyimide particles, nylon particles, polytetrafluoroethylene particles, and polycarbonate particles. In some embodiments, the surface coating is deformed under an applied mechanical embossing pressure. In some embodiments, the floor panels 400 comprise at least two portions having different tactile surface characteristics. In some embodiments, the floor panels 400 comprise a filler material. In some embodiments, the filler material is selected from: pecan shells; wood flour; saw dust; walnut shells; rice hulls; corn cob grit; ground shells from clams or coral; limestone; quartz; ceramic powder; glass; fly ash; concrete powder; and a combination of two or more thereof. In some embodiments, the filler material comprises limestone.

In other embodiments, the floor panels 400 may be from the Luxe plank line, also commercially available from Armstrong World Industries, Inc. Other floor coverings that may be used in combination with the integral composite underlayment 200 include, without limitation, dry-back residential tile, SUCCESSOR INTERFLEX sheet flooring, INITIATOR and STARSTEP sheet flooring in both conventional felt and ToughGuard® structures, and glass-encapsulated, vinyl-backed sheet structures, all in the vinyl flooring category and all made by Armstrong World Industries, Inc., Lancaster, Pa.

Referring now to FIG. 8-9 concurrently, it will be explained how multiple runs of the integral composite underlayment 200 are used to cover the entire support surface 300 with the floating floor system 2000. To start, a first run 200A of the integral composite underlayment is positioned atop the support surface 300. A second run 200B of the integral composite underlayment is then positioned atop the support surface 300 adjacent the first run 200A. The first and second runs 200A, 200B are identical to the integral composite underlayment 200 discussed above with respect to FIGS. 1-4.

Once laid out, a first side edge portion 205B of the second run 200B of the integral composite underlayment is positioned beneath the edge region 215A of the lower surface 212A of the flexible support layer 210A of the first run 200A of the integral composite underlayment. As a result, an overlap seam 290 is formed. The adhesive layer 220B of the second run 200B of the integral composite underlayment adheres to the edge region 215A of the lower surface 21 IA of the flexible support layer 210A of the first run 200A of the integral composite underlayment, thereby joining the first and second runs 200A, 200B. As can be seen, the first edge 203B of the second run 200B of the integral composite underlayment may abut against the second side edge 234A of the flexible insulating layer 230A of the first run 200A of the integral composite underlayment.

While an overlap seam 290 is created, the floor panels 400 can be secured to the adhesive layers 220A, 220B of the first and second runs 220A right over the overlap seam 290 because only the slightest of bumps is present. This is due, in part, to the omission of the insulating layer 230A along the edge region 215A of the lower surface 211A of the flexible support layer 210A of the first run 200A of the integral composite underlayment. Thus, unlike previous flooring systems, the present invention is particularly useful for creating floating floor systems 2000 that utilize spaced apart floor panels 400 and a grout filler 75. In existing systems, grout lines must be kept away from the seams formed between adjacent runs of the underlayment due to grout cracking and degradation. In the present invention, however, the grout lines can be positioned right atop the overlap seam 90 with no grout cracking or degradation.

Thus, in one embodiment, the installation method may further comprise positioning the plurality of floor panels 400 atop the exposed portions of the pressure sensitive adhesive layers 220A, 220B of the first and second runs 220A, 200B of the integral composite underlayment in a spaced-apart manner from one another so that gaps 70 are created between the adjacent ones of the plurality of floor panels 400. The gaps 70 are then filled with a grout material 75, thereby defining a plurality of grout lines 77. In one arrangement, at least one of the grout lines 77 extends substantially parallel to the overlap seam 290 and is located atop the overlap seam 290.

The above flooring system 2000 also provides a floor covering in which a damaged or otherwise undesirable floor panel can easily be replaced. For the floating floor system 2000 of FIG. 9, the grout material 75 around the undesirable floor panel 400 is first scraped away for example, by using a utility knife. Once the grout material 75 has been removed, a corner or edge of the undesirable floor panel 400 is pried up using a bladed tool. The undesirable floor panel 400 is then peeled off of the pre-applied adhesive layer 220 to expose a portion of the pre-applied adhesive layer 220. A replacement floor panel 400 is then simply pressed onto the exposed portion of the pre-applied adhesive layer 220 to adhere the replacement floor panel 400 to the integral composite underlayment 200. No additional adhesive is used to adhere the replacement floor panel 400 to the integral composite underlayment 200. The pre-applied adhesive layer 220 is adequate to perform the required bonding. Once the replacement floor panel 400 is adhered place, the gaps are then re-grouted.

In an embodiment not shown, the upper surface 211 of the flexible support layer 210 may include gridline indicia that is visible through the adhesive layer 220 once the release layer 240 is removed. In such an embodiment, the gridline indicia may assist in proper placement and positioning of the floor panels 400. The gridlines indicia may be a printed layer atop the upper surface 211 of the flexible support layer 210 or can be formed by debossing.

As used throughout, ranges are used as shorthand for describing each and every value that is within the range. Any value within the range can be selected as the terminus of the range. In addition, all references cited herein are hereby incorporated by referenced in their entireties. In the event of a conflict in a definition in the present disclosure and that of a cited reference, the present disclosure controls.

While the foregoing description and drawings represent some example systems, it will be understood that various additions, modifications and substitutions may be made therein without departing from the spirit and scope and range of equivalents of the accompanying claims. In particular, it will be clear to those skilled in the art that the present invention may be embodied in other forms, structures, arrangements, proportions, sizes, and with other elements, materials, and components, without departing from the spirit or essential characteristics thereof. In addition, numerous variations in the methods/processes. One skilled in the art will further appreciate that the invention may be used with many modifications of structure, arrangement, proportions, sizes, materials, and components and otherwise, used in the practice of the invention, which are particularly adapted to specific environments and operative requirements without departing from the principles of the present invention. The presently disclosed embodiments are therefore to be considered in all respects as illustrative and not restrictive, the scope of the invention being defined by the appended claims and equivalents thereof, and not limited to the foregoing description or embodiments. Rather, the appended claims should be construed broadly, to include other variants and embodiments of the invention, which may be made by those skilled in the art without departing from the scope and range of equivalents of the invention.

1. An underlayment apparatus for a floating floor, the underlayment apparatus comprising:
a core tube;
an integral composite underlayment wrapped around the core tube, the integral composite underlayment alterable between: (1) a rolled state in which the integral composite underlayment is wrapped around the core tube; and (2) an unrolled state in which the integral composite underlayment lays substantially flat on a support surface;
the integral composite underlayment comprising:
a flexible support layer having an upper surface and a lower surface;
a pressure sensitive adhesive layer disposed on the upper surface of the flexible support layer;
an insulating layer disposed on the lower surface of the flexible support layer; and
a release layer disposed on the pressure sensitive adhesive layer.

2. The underlayment apparatus according to claim 1 further comprising:
the flexible support layer comprising a first side edge and a second side edge;
the insulating layer comprising a first side edge and a second side edge; and
the second side edge of the insulating layer inwardly offset from the second side edge of the flexible support layer, thereby resulting in the lower surface of the flexible support layer comprising an edge region that is free of the insulating layer.

3.-4. (canceled)

5. The underlayment apparatus according to claim 2 wherein the edge region of the lower surface of the flexible support layer extends along an entire length of the integral composite underlayment, and the integral composite underlayment is wrapped around the core tube in a direction of the length of the integral composite underlayment in the rolled state.

6. (canceled)

7. The underlayment apparatus according to 2 wherein a ratio of a thickness of the insulating layer to a combined thickness of the release layer, the pressure sensitive adhesive layer, and the flexible support layer is at least 1.3:1.

8.-9. (canceled)

10. The underlayment apparatus according to claim 1 wherein an exposed lower surface of the integral composite underlayment is free of adhesive.

11. (canceled)

12. The underlayment apparatus according to claim 1 wherein the core tube has an outer diameter, and the integral composite underlayment has a thickness; and wherein a ratio of the outer diameter of the core tube to the thickness of the integral composite underlayment is in a range of 70:1 to 100:1.

13. The underlayment apparatus according to claim 1 wherein the core tube has an outer diameter, and the flexible support layer has a thickness; and wherein a ratio of the outer diameter of the core tube to the thickness of the flexible support layer is in a range of 350:1 to 400:1.

14. The underlayment apparatus according to claim 1 wherein the insulating layer is formed of a flock material, having a fiber length of 0.4 to 0.8 mm and a fiber diameter of 9 to 14 microns.

15.-16. (canceled)

17. The underlayment apparatus according to claim 1 wherein the release layer is a wax-coated cellulosic material, the flexible support layer is vinyl, the pressure sensitive adhesive layer is a pressure sensitive acrylic adhesive, and the insulating layer is an acrylic flock material.

18. (canceled)

19. The underlayment apparatus according to claim 1 wherein the integral composite underlayment has a weight per area between 0.07 to 0.10 pounds per square foot.

20.-21. (canceled)

22. An integral composite underlayment comprising:
a flexible support layer having an upper surface and a lower surface;
an adhesive layer disposed on the upper surface of the flexible support layer;
an insulating layer disposed on the lower surface of the flexible support layer; and
a release layer coupled to disposed on the adhesive layer.

23. The integral composite underlayment according to claim 22 further comprising:
the flexible support layer comprising a first side edge and a second side edge;
the insulating layer comprising a first side edge and a second side edge; and
the second side edge of the insulating layer inwardly offset from the second side edge of the flexible insulating layer, thereby resulting in the lower surface of the flexible support layer comprising an edge region that is free of the insulating layer.

24. The integral composite underlayment according to claim 23 wherein the edge region of the lower surface of the flexible support layer is free of an adhesive.

25. The integral composite underlayment according to claim 23 wherein the first side edges of the insulating layer and the flexible support layer are substantially flush with one another.

26. The integral composite underlayment according to claim 23 wherein the second side edges of the insulating layer and the flexible support layer are substantially parallel to one another.

27.-29. (canceled)

30. The integral composite underlayment according to claim 23 wherein the release layer has a thickness, the adhesive layer has a thickness, the flexible support layer has a thickness, and the insulating layer has a thickness; and wherein the thickness of the insulating layer is greater than the thickness of the flexible support layer, the thickness of the flexible support layer is greater than the thickness of the release layer, and the thickness of the release layer is greater than the thickness of the adhesive layer.

31. (canceled)

32. The integral composite underlayment according to claim 22 wherein the release layer is a wax-coated cellulosic material, the flexible support layer is vinyl, the adhesive layer is a pressure sensitive adhesive, and the insulating layer is a flock material.

33. (canceled)

34. The integral composite underlayment according to claim 22 wherein the adhesive layer has a tack value between 740 to 800 gm.

35.-36. (canceled)

37. The integral composite underlayment according to claim 22 further comprising gridline indicia on an upper surface of the release layer.

38.-59. (canceled)

60. An underlayment apparatus for a floating floor, the underlayment apparatus comprising:
a core tube;
an integral composite underlayment wrapped around the core tube, the integral composite underlayment alterable between: (1) a rolled state in which the integral composite underlayment is wrapped around the core tube; and (2) an unrolled state in which the integral composite underlayment lays substantially flat on a support surface;
the integral composite underlayment comprising:
a flexible support layer having an upper surface and a lower surface;
a pre-applied pressure sensitive adhesive layer disposed on the upper surface of the flexible support layer; and
a release layer disposed on the pressure sensitive adhesive layer.

61.-65. (canceled)
